(19) United States
(12) Patent Application Publication
(10) Pub. No.: US 2021/0162750 A1
(43) Pub. Date: Jun. 3, 2021

(54) INKJET DEVICE WITH POSITION-ADJUSTABLE INKJET HEADS

(71) Applicant: Great Computer Corp., New Taipei City (TW)

(72) Inventors: Liang SHIH, New Taipei City (TW); Chen-Chien TSAI, New Taipei City (TW); Hui-Te YU, New Taipei City (TW)

(21) Appl. No.: 16/700,144

(22) Filed: Dec. 2, 2019

(51) Int. Cl. B41J 2/145; B41J 2/21

(52) U.S. Cl. CPC B41J 2/145; B41J 2/2103

(57) ABSTRACT

The present invention provides an inkjet device with position-adjustable inkjet heads comprising a body and a plurality of inkjet heads. The body is provided with at least one first region and a plurality of second regions, and the first region and the plurality of second regions are spaced apart from each other on the body. The plurality of inkjet heads is respectively provided on the body, and the plurality of inkjet heads comprises a first inkjet head having a specific color ink and a plurality of second inkjet heads having chromatic inks. Moreover, the first inkjet head is provided on the first region, and the plurality of second inkjet heads is provided on the second regions, and the first inkjet head or the plurality of second inkjet heads is moved on the first region or the second regions.

### FIELD OF THE INVENTION

The present invention is related to an inkjet device, which includes inkjet heads that are position-adjustable, according to the actual needs, so to achieve an optimal productivity, and is particularly suitable to be used for a large-scale UV inkjet printer.

### BACKGROUND OF THE INVENTION

Since UV inkjet is able to be printed on many objects to be printed made of different materials or with different thicknesses by using an UV inkjet printer, in addition to faster printing performance and consistent and stable print quality, the reliable performance of the UV inkjet printer also make it not necessary to use the color separation screen, so as to print quickly, thereby making UV inkjet printers widely used in professional commercial output applications such as advertisements, posters and high-quality art reproductions.

Currently, a conventional UV inkjet printer in the market mainly has an inkjet module that can be controlled to move back and forth on the sliding platform of the conventional UV inkjet printer. A plurality of ink cartridges is provided above the inkjet module, and a plurality of inkjet heads, such as inkjet heads of chromatic or a certain specific color (white or transparent) corresponding to the respective ink cartridges, is located under the inkjet module. After being printed onto the object to be printed, the ink is hardened and quickly solidified by applying UV light onto the ink that has been printed on the object to be printed via an UV lamp provided on the side of the inkjet module.

Currently, the method of increasing output for specific color is to arrange the special color inkjet head and the chromatic inkjet head in different locations, so that the output of the chromatic ink and the specific color ink can be completed simultaneously in one working process. However, in the case of a stack printing or over printing application, such arrangement of above inkjet heads would reduce its productivity.

### SUMMARY OF THE INVENTION

Therefore, how to effectively improve the above-mentioned printing defects generated by the UV inkjet printer during stacking printing, so as to further improve the printing efficiency of the UV inkjet, which persons skilled in the art and users hope to accomplishment.

The main object of the present invention is to provide an inkjet device with position-adjustable inkjet heads, which has simple structure and low cost, and can effectively improve the printing speed, so as to optimize the productivity.

In order to fulfill above object, the inkjet device with position-adjustable inkjet heads, comprises a body and a plurality of inkjet heads. The body is provided with at least one first region and a plurality of second regions thereon, wherein the first region and the plurality of second regions are spaced apart from each other on the body. The plurality of inkjet heads, respectively provided on the body, wherein the plurality of inkjet heads comprises a first inkjet head having a specific color ink and a plurality of second inkjet heads having chromatic inks. The first inkjet head is provided on the first region, and the plurality of second inkjet heads is provided on the second region, and the first inkjet head or the plurality of second inkjet heads is moved on the first region or the second region.

In an implementation, the plurality of second inkjet heads is fixed on the second region, and the first inkjet head can be moved on the first region, and the first inkjet head can be accurately positioned by a positioning structure after being moved.

In an implementation, the first inkjet head is fixed on the first region, and the plurality of second inkjet heads is synchronously moved on the second region, and the plurality of second inkjet heads is accurately positioned by a positioning structure after being moved.

In an implementation, the positioning structure includes a positioning member provided around the first region or the second regions and a positioning block provided on the first inkjet head or the plurality of second inkjet heads, thereby the first inkjet head or the plurality of second inkjet heads is moved, such that the first inkjet head or the plurality of second inkjet heads is accurately positioned at a predetermined position by having the positioning block in contact with the positioning member.

The present invention will be understood more fully by reference to the detailed description of the drawings and the preferred embodiments below.

### BRIEF DESCRIPTION OF DRAWINGS

FIG. 1 is a flow chart of an embodiment of the present invention.

FIG. 2 is a schematic diagram showing the state of continuous operation of the embodiment of the present invention.

### DETAILED DESCRIPTIONS OF PREFERRED EMBODIMENTS

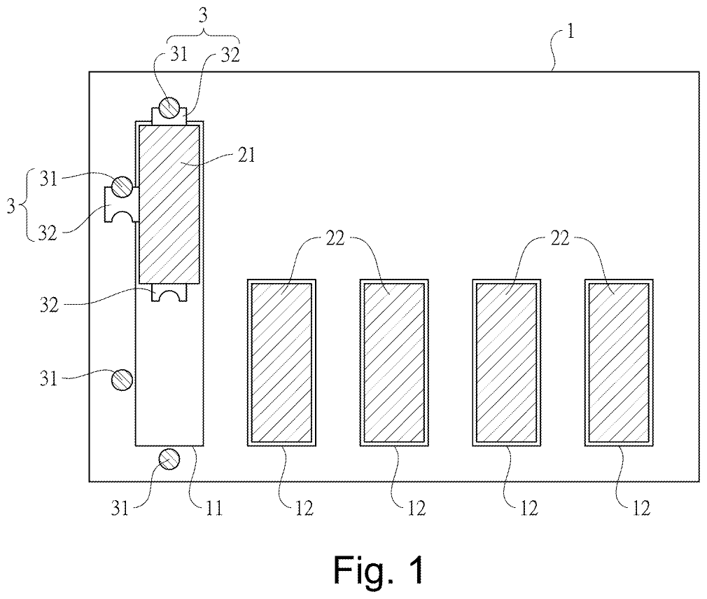

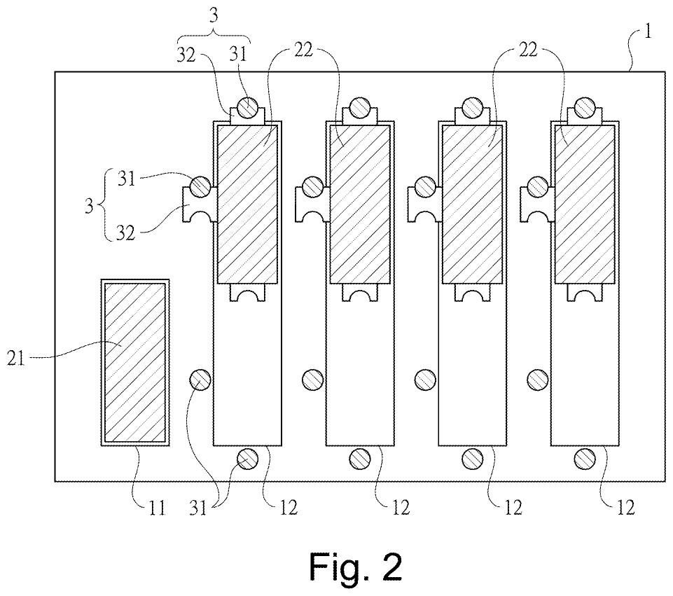

Please refer to FIGS. 1 and 2, which showing an embodiment of inkjet device with position-adjustable inkjet heads of the present invention.

The present invention provides an inkjet device with position-adjustable inkjet heads comprising a body 1 and a plurality of inkjet heads 2. The body 1 is provided with at least one first region 11 and a plurality of second regions 12, and the first region 11 and the plurality of second regions 12 are spaced apart from each other on the body 1. The plurality of inkjet heads 2 is respectively provided on the body 1, and the plurality of inkjet heads 2 comprises a first inkjet head 21 having a specific color ink and a plurality of second inkjet heads 22 having chromatic inks. Moreover, the first inkjet head 21 is provided on the first region 11, and the plurality of second inkjet heads 22 is provided on the second regions 12, and the first inkjet head 21 or the plurality of second inkjet heads 22 is moved on the first region 11 or the second regions 12.

In one embodiment, the plurality of second inkjet heads 22 is fixed on the second regions 12, and the first inkjet head 21 can be moved on the first region 11, and as shown in FIG. 1, the first inkjet head 21 can be accurately positioned by a positioning structure 3 after being moved. In another embodiment, the first inkjet head 21 is fixed on the first region 11, and the plurality of second inkjet heads 22 is synchronously moved on the second regions 12, and as shown in FIG. 2, the plurality of second inkjet heads 22 is accurately positioned by a positioning structure 3 after being moved.

The positioning structure 3 includes a positioning member 31 provided around the first region 11 or the second regions 12 and a positioning block 32 provided on the first inkjet head 21 or the plurality of second inkjet heads 22. Thereby, the first inkjet head 21 or the plurality of second inkjet heads 22 is moved, such that the first inkjet head 21 or the plurality of second inkjet heads 22 is accurately positioned at a predetermined position by having the positioning block 32 in contact with the positioning member 31.

Accordingly, through the above arrangements, users can adjust the position of the first inkjet head having the specific color ink or the plurality of the second inkjet head having the chromatic ink in the inkjet printing process according to different requirements, and above process can be completed by the same inkjet module. The inkjet device with position-adjustable inkjet heads of the present invention not only has simple structural design and low cost, and the printing efficiency of the stack printing can be greatly improved. Moreover, through the positioning structure of the present invention, the first inkjet head or the plurality of second inkjet heads can be accurately positioned at the correct positions after being moved without causing the printing misalignment

The description referred to the drawings and stated above is only for the preferred embodiments of the present invention. Many equivalent variations and modifications can still be made by those skilled in the field of the present invention without departing from the spirit of the present invention, and they should be regarded to fall into the scope defined by the appended claims.

To sum up, the inkjet device with position-adjustable inkjet heads provided by the present invention can indeed meet its anticipated objects, and can be put into industrial use.

1. An inkjet device with position-adjustable inkjet heads, comprising:
a body, provided with at least one first region and a plurality of second regions thereon, wherein the first region and the plurality of second regions are spaced apart from each other on the body;
a plurality of inkjet heads, respectively provided on the body, wherein the plurality of inkjet heads comprises a first inkjet head having a specific color ink and a plurality of second inkjet heads having chromatic inks, and the first inkjet head is provided on the first region, and the plurality of second inkjet heads is provided on the second regions, and the first inkjet head or the plurality of second inkjet heads is moved on the first region or the second regions,
wherein the plurality of second inkjet heads are fixed on the second regions while the first inkjet head can be moved to a different location on the first region, or the first inkjet head is fixed on the first region while the plurality of second inkjet heads are synchronously moved to a different location on the second regions.

2. The inkjet device with position-adjustable inkjet heads according to claim 1, wherein the first inkjet head can be accurately positioned by a positioning structure after being moved.

3. The inkjet device with position-adjustable inkjet heads according to claim 2, wherein the positioning structure includes a positioning member provided around the first region or the second regions and a positioning block provided on the first inkjet head or the plurality of second inkjet heads, thereby the first inkjet head or the plurality of second inkjet heads is moved, such that the first inkjet head or the plurality of second inkjet heads is accurately positioned at a predetermined position by having the positioning block in contact with the positioning member.

4. The inkjet device with position-adjustable inkjet heads according to claim 1, wherein the plurality of second inkjet heads is accurately positioned by a positioning structure after being moved.

5. The inkjet device with position-adjustable inkjet heads according to claim 4, wherein the positioning structure includes a positioning member provided around the first region or the second regions and a positioning block provided on the first inkjet head or the plurality of second inkjet heads, thereby the first inkjet head or the plurality of second inkjet heads is moved, such that the first inkjet head or the plurality of second inkjet heads is accurately positioned at a predetermined position by having the positioning block in contact with the positioning member.
